(19) United States
(12) Patent Application Publication
(10) Pub. No.: US 2013/0042089 A1
(43) Pub. Date: Feb. 14, 2013

(54) WORD LINE LATE KILL IN SCHEDULER

(71) Applicants: James Vinh, San Jose, CA (US); Srikanth Arekapudi, Sunnyvale, CA (US); Kyle S. Viau, Fremont, CA (US)

(72) Inventors: James Vinh, San Jose, CA (US); Srikanth Arekapudi, Sunnyvale, CA (US); Kyle S. Viau, Fremont, CA (US)

(73) Assignee: ADVANCED MICRO DEVICES, INC., Sunnyvale, CA (US)

(21) Appl. No.: 13/207,724

(22) Filed: Aug. 11, 2011

(51) Int. Cl. G06F 9/30

(52) U.S. Cl. 712/205; 712/E09.016

(57) ABSTRACT

A method for picking an instruction for execution by a processor includes providing a multiple-entry vector, each entry in the vector including an indication of whether a corresponding instruction is ready to be picked. The vector is partitioned into equal-sized groups, and each group is evaluated starting with a highest priority group. The evaluating includes logically canceling all other groups in the vector when a group is determined to include an indication that an instruction is ready to be picked, whereby the vector only includes a positive indication for the one instruction that is ready to be picked.

### FIELD OF INVENTION

The present invention is generally directed to multi-issue processor execution unit architecture and in particular, to a scheduler for use in a multi-issue processor or processor core.

### BACKGROUND

A typical processor includes several functional blocks. Such blocks typically include an instruction execution unit, a control unit, a register array, and one or more system buses. The instruction execution unit may be divided into integer execution unit(s) and floating point execution unit(s).

The control unit generally controls the movement of instructions into and out of the processor, and also controls the operation of the instruction execution unit. The control unit generally includes circuitry to ensure that all instructions are processed and executed at the correct time. Different portions of the control unit control the flow of instructions to the integer portions and the floating point portions of the execution units. The register array provides internal memory that is used for the quick storage and retrieval of data and instructions. The system buses typically include control buses, data buses, and address buses. The system buses are generally used for connections between the processor, memory, and peripherals, and for data transfers.

Modern processor architectures use multiple execution units typically arranged in a pipelined architecture. This architecture allows the processor to execute several complex instructions per clock cycle. Each pipeline may simultaneously execute a separate instruction. But, simultaneous execution of instructions may present timing problems because some instructions are executed out of order. In some cases, the destination (or output) of one instruction may be required as a source (or input) for another instruction. The control circuitry that schedules execution of instructions needs to ensure that the inputs for later instructions are ready prior to execution. An instruction may be scheduled for execution only when all of its inputs and its destination are available.

### SUMMARY OF EMBODIMENTS OF THE INVENTION

A method for picking an instruction for execution by a processor includes providing a multiple-entry vector, each entry in the vector including an indication of whether a corresponding instruction is ready to be picked. The vector is partitioned into equal-sized groups, and each group is evaluated starting with a highest priority group. The evaluating includes logically canceling all other groups in the vector when a group is determined to include an indication that an instruction is ready to be picked, whereby the vector only includes a positive indication for the one instruction that is ready to be picked.

A scheduler in a processor for picking an instruction for execution by the processor includes a picker and a wake array. The picker is configured to provide a multiple-entry vector, each entry in the vector including an indication of whether a corresponding instruction is ready to be picked. The wake array is configured to partition the vector into equal-sized groups and evaluate each group in the vector, starting with a highest priority group. The evaluating includes logically canceling all other groups in the vector when a group is determined to include an indication that an instruction is ready to be picked, whereby the vector only includes a positive indication for the one instruction that is ready to be picked.

A computer-readable storage medium storing a set of instructions for execution by one or more processors to facilitate manufacture of a scheduler. The scheduler includes a picker and a wake array. The picker is configured to provide a multiple-entry vector, each entry in the vector including an indication of whether a corresponding instruction is ready to be picked. The wake array is configured to partition the vector into equal-sized groups and evaluate each group in the vector, starting with a highest priority group. The evaluating includes logically canceling all other groups in the vector when a group is determined to include an indication that an instruction is ready to be picked, whereby the vector only includes a positive indication for the one instruction that is ready to be picked.

### BRIEF DESCRIPTION OF THE DRAWINGS

A more detailed understanding may be had from the following description, given by way of example in conjunction with the accompanying drawings, wherein:

FIG. 1 is a simplified block diagram of a processor core;

FIG. 2 is a simplified block diagram of an integer scheduler;

FIG. 3 is a simplified block diagram of the wake array and compare circuit shown in FIG. 2;

FIG. 4 is a block diagram showing a more detailed drawing of the wake array and compare circuit shown in FIG. 3;

FIG. 5 is a block diagram showing source ready circuitry;

FIG. 6 is a block diagram showing the picker logic;

FIG. 7 is a block diagram showing the logic to identify higher priority scheduler entries;

FIGS. 8A and 8B are a flowchart of a method for selecting a highest priority scheduler entry; and

FIGS. 9A and 9B are a block diagram showing source ready circuitry and logic to identify higher priority scheduler entries.

### DETAILED DESCRIPTION

A typical processor is configured to execute a series of instructions selected from its associated instruction set. A computer program, typically written in a high level language (e.g., C++), is typically compiled into machine code or assembly language (i.e., into the instruction set for the processor). The computer program is a set of instructions arranged in a specific order, and the processor is tasked with executing the set of instructions in their original order. Processors having multiple execution units may execute some of these instructions in parallel or otherwise out of order. Often, the destination (or output) of one instruction is used as a source (or input) for another instruction.

To address such timing issues, a scheduler is used to select instructions for execution. Schedulers may be provided for controlling integer instruction execution and floating point instruction execution. The scheduler determines whether a given instruction lacks one or more sources; if so, the instruction is considered “not ready.” If the scheduler determines that an instruction has all sources available, the instruction is considered “ready.”

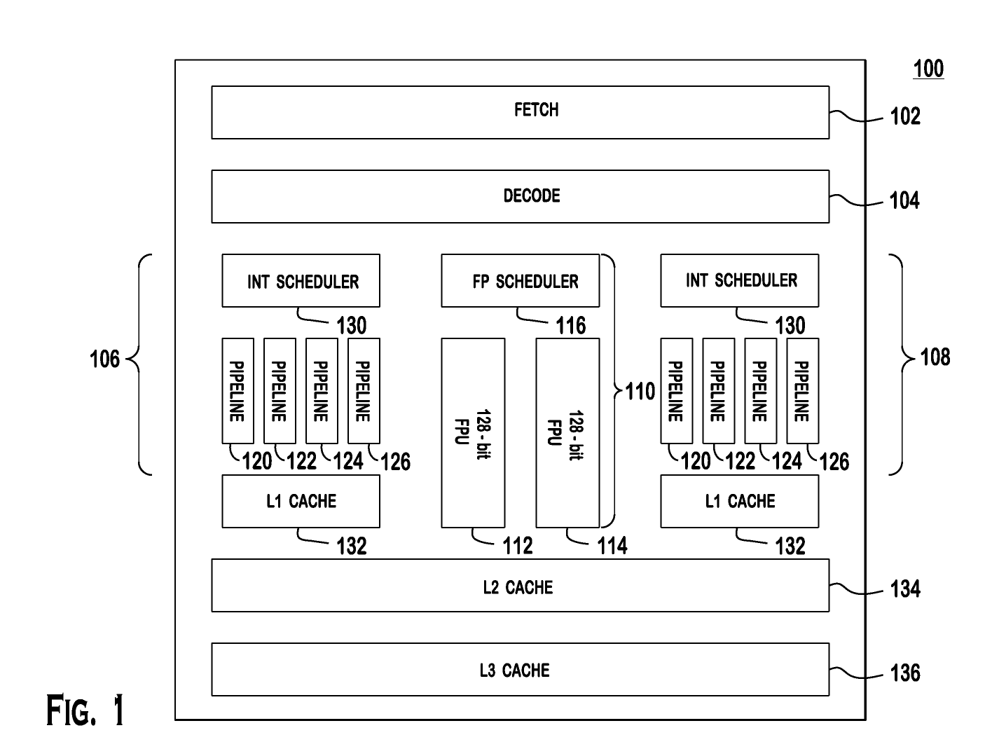

FIG. 1 is a simplified block diagram of an exemplary processor core 100. The processor core 100 includes an instruction fetch unit 102, an instruction decode unit 104, two integer execution units 106, 108, and a floating point execution unit 110. It should be understood that multiple processor cores may be used in a single processor.

The floating point execution unit 110 includes two 128-bit floating point units (FPU) 112, 114. Each FPU 112, 114 is configured to execute floating point instructions under control of a floating point scheduler 116. Each integer execution unit 106, 108 includes a plurality of pipelines 120, 122, 124, and 126 under control of an integer scheduler 130. The processor core 100 also has L1, L2, and L3 cache memories 132, 134, 136.

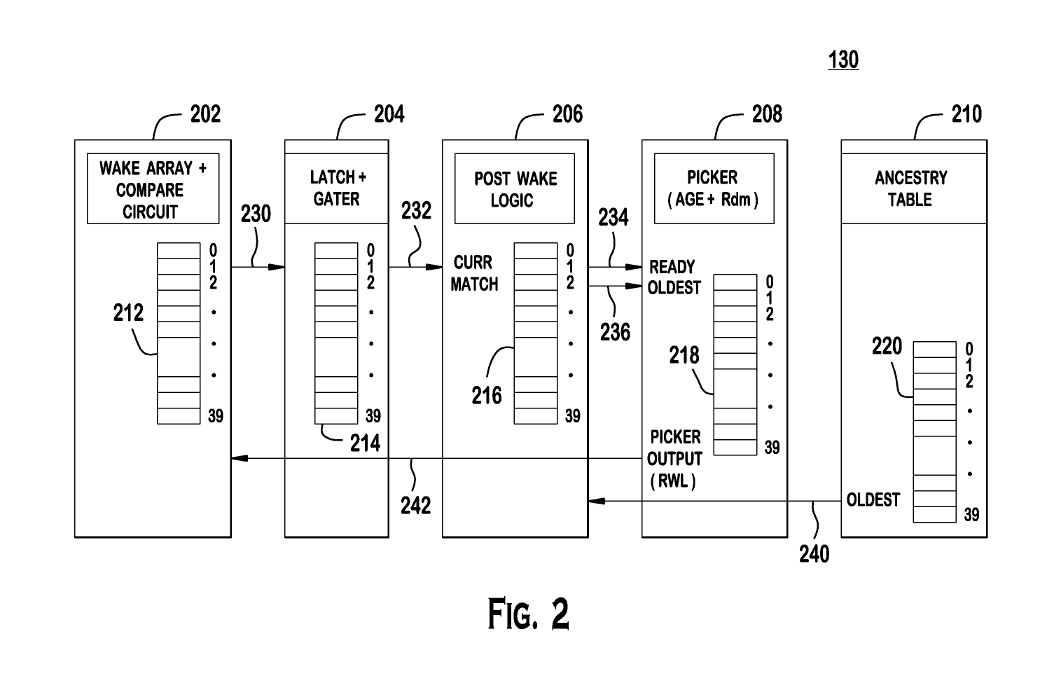

FIG. 2 is a simplified block diagram of an integer scheduler 130. It should be understood that the integer scheduler 130 may be used in a variety of processor architectures, and is not limited to use with the processor core disclosed in FIG. 1. It should also be understood that an integer scheduler may perform other functions and may contain additional circuitry beyond what is disclosed herein. In this particular example, the integer scheduler 130 is configured for use with four pipelines, and is referred to as a four-issue integer scheduler. It should be understood that the integer scheduler 130 may be used with any number of pipelines. Accordingly, the disclosure contained herein is applicable to a multi-issue integer scheduler that may be associated with any number of pipelines.

The integer scheduler 130 includes a wake array and compare circuit (wake array logic circuit) 202, a latch and gater circuit (latch circuit) 204, a post wake logic circuit 206, a picker 208, and an ancestry table (age array) 210. The integer scheduler 130 is configured to handle the scheduling of forty instructions (numbered 0-39) as shown schematically by blocks 212-220. Block 212 has forty entries that generally contain vectors associated with forty instructions that are to be scheduled. The remaining blocks 214-220 generally represent read word lines associated with the entries in block 212. Each read word line is assigned a location (0-39) that corresponds to one of the forty vectors in block 212. The read word lines in the integer scheduler 130 are implemented in a fully decoded form (i.e., no decoding is required).

As a given instruction is executed (and the instruction status is good), its vector is removed or deallocated (i.e., retired) from the scheduler 130 and a new vector is inserted so that a new instruction can be scheduled. Blocks 202-210 are generally arranged in a circular configuration for continuous operation. As such, the interconnection of blocks 202-210 does not have a specific beginning or end. A description of blocks 202-210 is set out below without regard for the order of the individual blocks. As discussed above, the interconnections between blocks 202-210 may be implemented with multiple read word lines (e.g., one or more read word lines per scheduler entry). Although lines 230-242 are shown as single lines for matters of simplicity, they represent one or multiple read word lines.

The ancestry table 210 tracks which instruction is the oldest and produces an output 240 to identify the oldest instruction. The post wake logic circuit 206 is configured to determine which instructions are ready to be executed, based on the current match input 232 and drives the ready line 234 and the oldest line 236. The picker 208 receives the ready line 234 and the oldest line 236, picks one or more instructions for execution, and drives picker output lines 242.

The wake array logic circuit 202 determines the destination address of the instruction that corresponds to the picked scheduler entry. This destination address is compared to all source addresses (e.g., four sources for each entry in the scheduler 130). The wake array logic circuit 202 identifies a match between any of the source addresses and destination addresses. A match indicates that these sources will be available within a number of clock cycles, since the picked instruction will be executed and the location will have valid data. The wake array logic circuit 202 of completes the loop by driving the current match input 232 via the latch circuit 204. A more detailed description of each block is set out below.

The post wake logic circuit 206 is configured to determine which instructions are ready. An instruction may be considered “ready” when all necessary resources are available. During instruction execution, typical resources include “source” information (input information) retrieved from a source memory location. Results from instruction execution are stored in a “destination” memory location. A single instruction typically requires one or more sources. A source is considered available if the data at that memory location is speculatively valid.

For example, assume that a given instruction requires two different sources, such as an “ADD” instruction that adds two sources and places the result in a destination. Each of these sources must have speculatively valid data before the instruction may be considered to be ready. For example, instruction “A” is using the destination (or result) of another instruction “B” as one of its sources “C.” If instruction “B” is scheduled for execution, then source “C” is speculatively valid because the execution result of instruction “B” may itself be speculative (not valid). Depending on the instruction set, an instruction may require more than two sources. In this example, the instruction set for the processor core shown in FIG. 1 may have instructions requiring up to four sources.

The post wake logic circuit 206 receives current match input lines 230 from the latch circuit 204 as will be discussed in greater detail below. The post wake logic circuit 206 also receives oldest line 240 from the ancestry table circuit 210. Based on these inputs, the post wake logic circuit 206 drives the ready line 234 and the oldest line 236.

In this example, the current match input lines 232, 234 and the oldest line 240 are combined through the post wake logic circuit 206 and the picker logic circuit 208 to generate forty separate read word lines. Each read word line may have a logical value of 0 or 1. The ready output lines 234 identify all instructions that are ready. For example, if instructions corresponding to entries 0, 4, and 12 are ready, then lines 0, 4, and 12 will be set to logical value 1. The remaining lines will be set to logical value 0. The oldest instruction will have a logical value 1 on its corresponding oldest line 140. For example, if instruction 14 is the oldest and it is ready, then read word line 14 will be set to logical value 1 and the remaining read word lines will be set to logical 0.

The picker 208 receives the ready line 234 and the oldest output line 236 and drives the picker output lines 242. The picker 208 uses two basic criteria for picking an instruction for execution. The picker 208 selects the oldest instruction only if that instruction is ready; otherwise, the picker uses a random function to pick instructions from all available instructions that are ready.

In this example, the scheduler 130 is used in connection with a four-issue processor core. The picker 208 is configured to pick four instructions for execution. Several scenarios may be used to pick instructions for execution in accordance with some basic criteria, aside from random selection. For example, assume that ten instructions are ready, corresponding to entries 1, 2, 4, 6, 7, 9, 11, 14, 19, and 25, and that none of these instructions are the oldest. The picker 130 may select instructions based on instruction position, highest numeric entry, lowest numeric entry, and/or instruction type. Instruction types may be classified in a variety of categories such as: EX (executable instructions) such as add, subtract, multiply, divide, and shift; and AG—load/store based instructions (e.g., instructions that require address calculations).

Continuing with this example, the picker 208 may select the highest and lowest entries, 1 and 25, and then randomly select one EX instruction and one AG instruction from the remaining entries. It should be understood that the instruction type may be supplied via a variety of methods. Other instruction picking approaches may be used without departing from the scope of this disclosure. The picker 208 may be configured to select four entries, or the picker 208 may be divided into four independent picker units. Each picker unit may select an instruction for execution, run independently, and drive its own set of forty read word lines.

As explained briefly above, the ancestry table 210 generally tracks which instruction is the oldest and produces an output to identify this instruction. In this example, the ancestry table 210 drives the oldest bus 240 in one-hot format (one line for each bit). The oldest instruction will have a logical value 1 on its corresponding oldest entry. For example, if instruction 14 is the oldest, then bit 14 on the oldest bus 140 will be set to logical value 1 and the remaining bits of oldest bus 140 will be set to logical 0.

The picker output 242 is supplied to the wake array logic circuit 202. As explained above, the picker output 242 identifies specific scheduler entries that are picked for execution. In one implementation, the picker output 242 is a one-hot vector, with the “1” bit indicating which instruction was picked, identified by a QID (queue identifier) that indicates the picked instruction's position in the vector. The wake array logic circuit 202 receives the picker output 242 and determines the destination address of the instruction that corresponds to the picked scheduler entry. In this example, the destination address is a physical register number (PRN). The destination PRN is compared to all source PRNs, e.g., four sources for each entry in the scheduler 130. The wake array logic circuit 202 identifies a match between any of the source PRNs and the destination PRN, and drives the current match input 232 via the latch circuit 204.

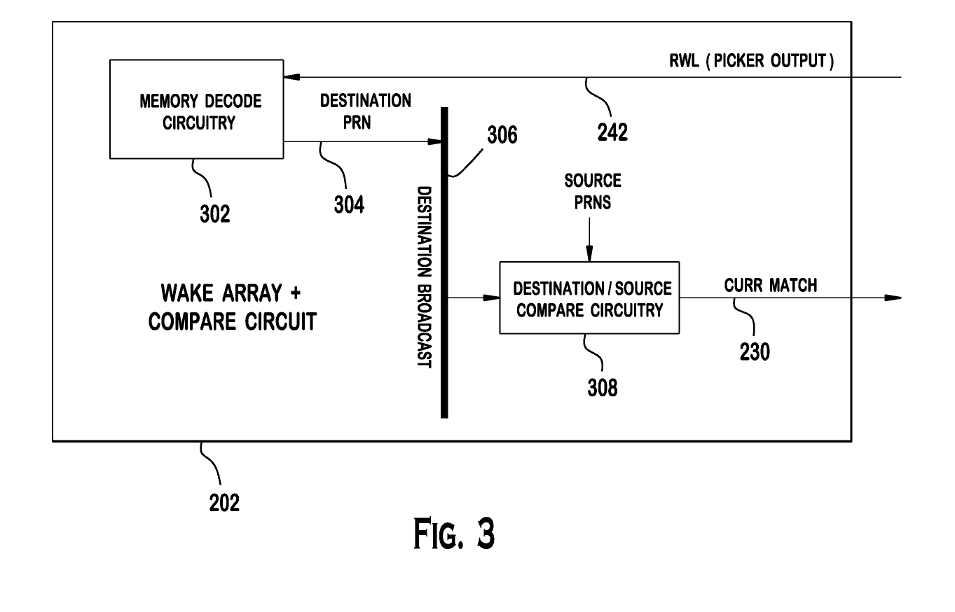

FIG. 3 is a simplified block diagram of the wake array and compare circuit 202 shown in FIG. 2. A logical 1 on the picker output line 242 signifies that a particular entry has been picked. The picker output 242 is fed into a memory decode circuit 302. It should be understood that the picker output 242 may also be routed to other circuitry. For example, the picker output 242 may be routed to circuitry that causes the execution of the picked instruction via one of the pipelines 120-126 (FIG. 1).

In the example embodiment shown in FIG. 3, the memory decode circuit 302 (also referred to as a random access memory (RAM) read section) generates an address output 304 which is coupled to a destination broadcast bus 306. The address output 304 is the destination PRN of the picked instruction that corresponds to the read word line 242. Because this instruction was picked for execution, the destination of this instruction will be valid within a fixed number of clock cycles. For example, using the processor core 100 shown in FIG. 1, the destination associated with this instruction will be valid within a number of clock cycles depending on the processor architecture used (e.g., two clock cycles).

A destination/source compare circuitry 308 (also referred to as a content addressable memory (CAM) section) is also coupled to the destination broadcast bus 306. The destination/source compare circuitry 308 compares the destination associated with the picked instruction with each source associated with each entry in the scheduler 130. The destination/source compare circuitry 308 drives the current match input lines 230 that are coupled to the post wake logic circuit 206. In this example, the scheduler 130 can track forty entries (i.e., forty instructions). Each instruction may have up to four sources. Accordingly, the destination/source compare circuitry 308 is configured to drive current match input lines 230 indicating that up to 160 sources match the destination of the picked instruction (e.g., 160 current match input lines). The current match input lines 230 allow the post wake logic circuit 206 to determine which instructions are ready, as discussed above.

As shown in FIG. 2, the latch circuit 204 is disposed between the wake array logic circuit 202 and the post wake logic circuit 206. The latch circuit 204 generally provides a latching function. The output of the latch circuit 204 (the current match input 232) is latched and provides a steady input to the post wake logic circuit 206. This allows the allows wake array logic circuit 202 to reset for the next cycle without affecting the current match input 232 to the post wake logic circuit 206. In this particular example, the latch circuit 204 is implemented with B-phase latches, which are open when the clock is a logic 0.

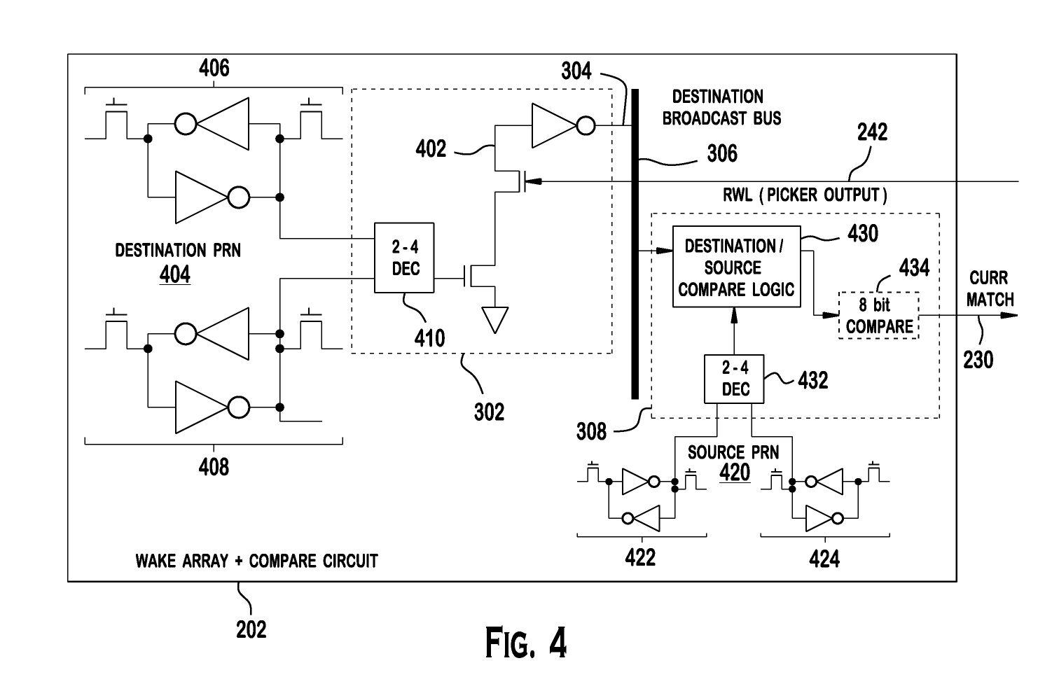

FIG. 4 is a block diagram showing a more detailed drawing of the wake array and compare circuit 202 shown in FIG. 3. As described above, a logical 1 on picker output line 242 signifies that a particular scheduler entry has been picked. The picker output 242 is fed into the memory decode circuit 302. In the example embodiment shown in FIG. 4, the memory decode circuit 302 includes input circuitry 402 coupled to a memory location 404. In this example, only two bits 406, 408 of the memory location 404 are shown. It should be understood that additional bits may be required to fully specify a given PRN. In this example, a 2-4 decoder 410 is used to conserve power and to provide a “one-hot” output.

The destination PRN in one-hot format is placed on the destination broadcast bus 306. Because this particular instruction was picked for execution, the destination of this instruction will be valid within a fixed number of clock cycles (e.g., two cycles). The destination/source compare circuitry 308 is also coupled to the destination broadcast bus 306. The destination/source compare circuitry 308 compares the destination PRN with each source PRN for each entry in the scheduler 130.

In this example, the destination/source compare circuitry 308 is implemented with destination/source compare logic 430 which compares the destination PRN with all source PRNs. In its simplest form, the destination/source compare logic 430 may contain a bank of 160 comparators that compare each source PRN to the destination PRN and directly drive the current match input lines 230. In this example, the source memory decoding circuitry also uses a 2-4 decoder 432. Only two bits 422, 424 of a memory location 420 are shown for purposes of clarity. It should be understood that additional bits may be required to fully specify a given PRN. It should also be understood that such circuitry may be duplicated to provide compare functionality for longer source PRNs (e.g., 8 bits).

The destination/source compare circuitry 308 may be implemented with multiple compare stages. For example, if four bits of the source PRN match the destination PRN, a subsequent compare may be carried out to determine if there is a match of all bits of the two PRNs (e.g., an 8 bit compare), as shown by block 434.

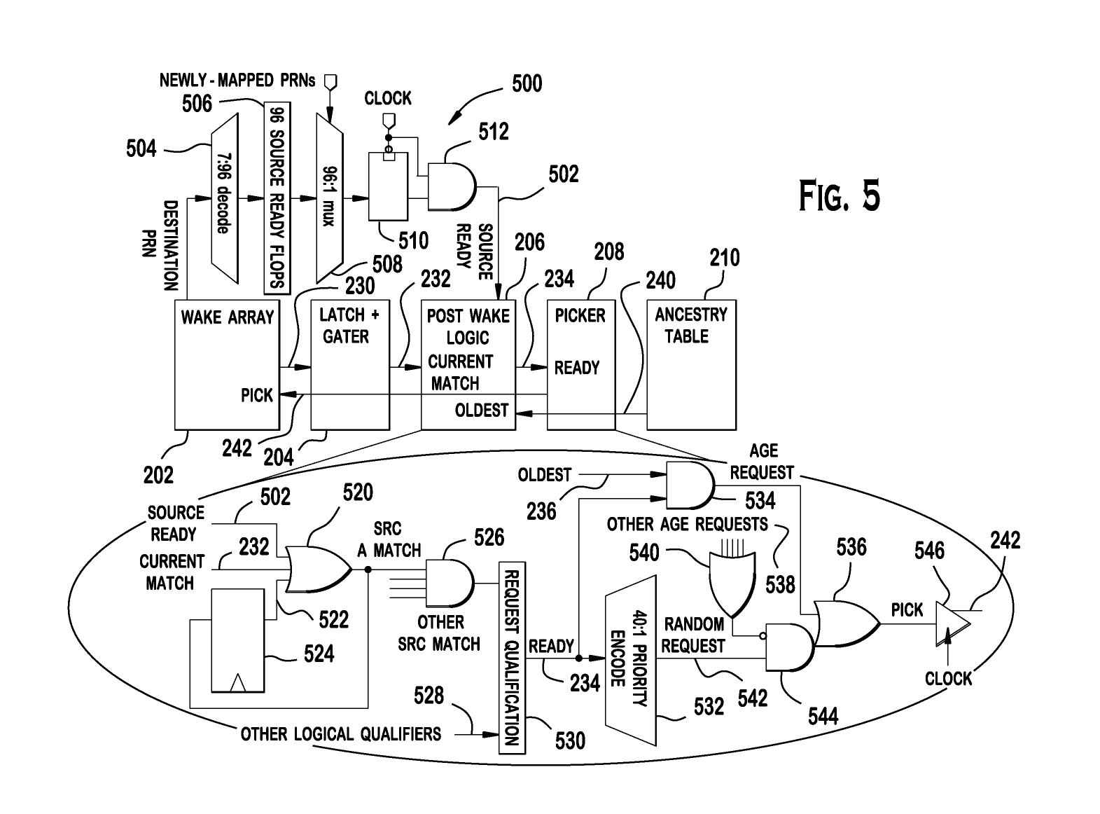

FIG. 5 is a block diagram showing source ready circuitry 500. The source ready circuitry 500 is used to detect the readiness of newly arrived sources of new instructions that have been dispatched to the scheduler 130. As described above, a newly mapped destination PRN is compared to all source PRNs, i.e., four sources for each entry in the scheduler 130. The wake array logic circuit 202 identifies a match between any of the source PRNs and the destination PRN and drives the current match input 232. The source ready output 502 and current match input 232 are used by the post wake logic circuit 206 to drive the ready line 234.

A newly woken up destination PRN from the wake array logic circuit 202 is sent to the source ready logic circuit 500 and is decoded via a 7:96 decoder 504 coupled to 96 source ready flip flops 506. It should be understood that seven bits may be decoded into 128 valid addresses; however, in this particular example, only 96 PRNs are used. The source ready flip flops 506 keep track of all sources inside the scheduler that are ready. The output of the source ready flip flops 506 is fed into a 96:1 multiplexer 508 which drives a flip flop 510. The source ready output 502 is gated via an AND gate 512.

FIG. 5 also includes a block diagram of circuitry contained in the post wake logic circuit 206 and the picker 208. The source ready signal 502 and the current match signal 232 are input to an OR gate 520 along with a gating signal 522 via a flip flop 524. The output of the OR gate 520 drives an AND gate 526. Other logical qualifiers 528 (e.g., other sources) are then combined and the ready output 234 is generated via block 530. It should be understood that the circuitry discussed above is replicated for multiple sources and for multiple scheduler entries.

The ready output 234 (40 lines) is coupled to a 40:1 priority encoder 532 and an AND gate 534. The ready output 234 is checked to determine if the associated scheduler entry is the oldest via the AND gate 534. If the entry is the oldest, then the entry is picked via an OR gate 536. Otherwise, the entry is picked based on all of the other age requests 538 via an OR gate 540 and a random request 542 from the priority encoder 532 by an AND gate 544. A driver 546 drives the pick signal 242 from the output of the OR gate 536.

The age-based picker provides the QID of the oldest instruction in the queue, but the oldest instruction might not be ready to be executed. If the oldest instruction is not ready to be picked, then the random picker is used. Two possible implementations of the random picker include traversing the vector from top-to-bottom or bottom-to-top (based on the numbering of the slots in the vector) and picking the first instruction that is ready. It is noted that other implementations of the random picker are also possible.

The goal of the picker is to generate a one-hot vector, with the one-hot being the picked instruction. Once the pick is made, the rest of the vector needs to be zeroed out, to make it one-hot. This one-hot vector is the pick signal, which is used as the RAM read input in the wake array 202. But the pick signal does not indicate the tag of the picked entry; the RAM contains the tag. With a one-hot vector, the RAM read is simple to implement and execute. But obtaining the one-hot vector (out of 40 possible entries) may be complicated to implement and may introduce difficulties in making the required timing.

Once the picker makes it pick (pick signal 242), the tag corresponding to the picked instruction is broadcast from the RAM read section into the CAM section to wake up all of the dependent sources, if they match the tag. Coming out of the CAM section, multiple instructions may be ready in the current cycle, because multiple instructions may be waiting for the same tag broadcast. But the number of instructions that may be picked is limited, based on the scheduler bandwidth.

The CAM section indicates which instructions are ready, while the post wake logic 206 checks for all other conditions. The output of the post wake logic 206 provides all of the instructions which are ready to be picked as a multi-hot vector, with all of the “hot” lines being the ready instructions.

Instead of zeroing out the non-picked slots in the ready vector in the picker, the ready vector may be divided into equal-sized groups and the “kill logic” to zero out the non-picked slots in the ready vector may be placed in the RAM read section. In one implementation (described in more detail herein), the ready vector is divided into eight groups of five lines each. It is noted that other implementations may divide the ready vector into group sizes other than groups of five lines. Within each group, there could be multiple ready instructions, and the first instruction in the group (based on the order within the vector) that is ready is the instruction to be picked from that group. Each group of five lines produces a one-hot 5-bit vector; these groups are combined to produce an 8-hot vector to be supplied to the picker.

But when the RAM read is performed, only one read may be performed at a time. The RAM read is started for each group, but when the read is started, it is not yet known which read is for the highest priority instruction (i.e., for which instruction will ultimately be picked). A second signal (a valid signal) is supplied for each group and is used to “kill” the lower priority groups. As the RAM read for all groups is started, and then all of the reads except one are terminated prior to completion, this is referred to as a “late kill.”

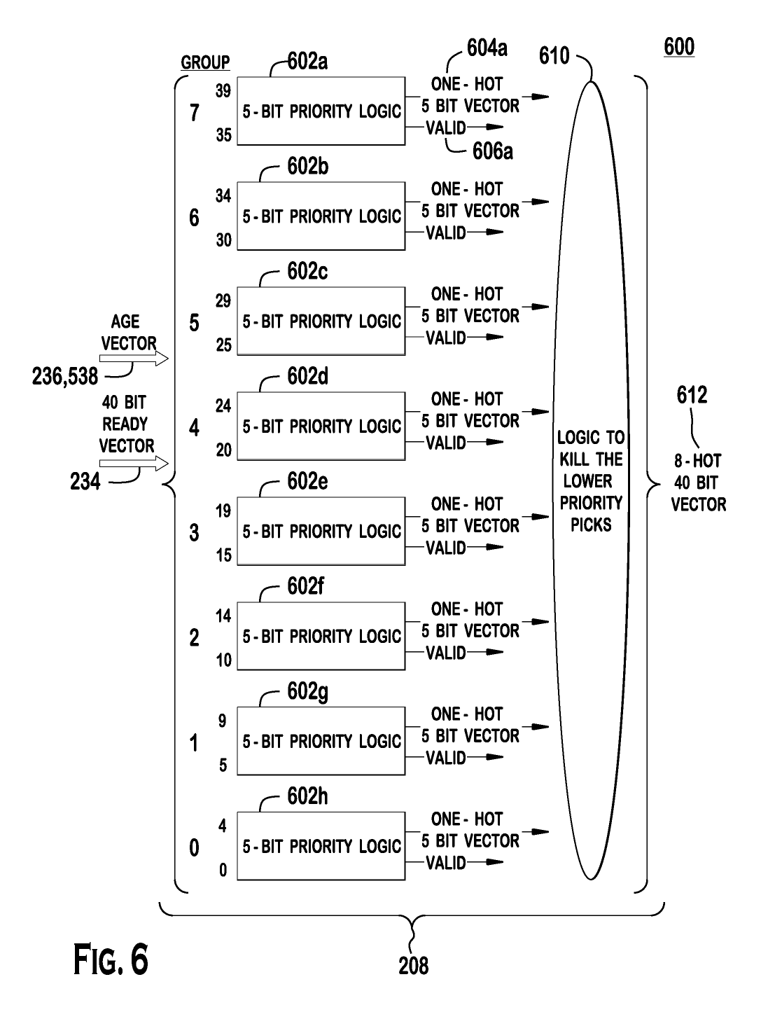

FIG. 6 is a block diagram showing the picker logic 600. The oldest vector 236, the other age vectors 538, and the 40-bit ready vector 234 are input to the picker 208. The ready vector 234 is grouped into eight 5-bit groups 602a-602h. In one embodiment, the groups 602a-602h are arranged from the most significant bit (bit position 39) to the least significant bit (bit position 0). In an alternate embodiment, this arrangement may be reversed, but the picker logic 600 will still operate in the same manner.

Each group 602a-602h is treated separately with a 5-bit priority logic, to generate a one-hot 5-bit vector 604a-604h and a valid signal 606a-606h. The valid signal 606 indicates whether the corresponding 5-bit vector 604 includes at least one “1.” If the valid signal 606 is a “1,” then the corresponding group 602 has at least one instruction that is ready to be picked. If the valid signal 606 is a “0,” then the corresponding group 606 does not have any ready instructions.

Once the valid signal 606 of one of the groups 602a-602h (taken in order from group 7 to group 0) is a “1,” logic 610 kills all of the lower priority groups. For example, if group 5 (602c) is the first group with a valid signal of “1,” then the remaining groups 602d-602h are killed by the logic 610.

In addition, an age-based pick that is ready may kill higher priority groups, as well as the lower priority groups. For example, if the oldest ready instruction is in group 4 (602d), the logic 610 kills groups 602a-602c and groups 602e-602h. Ultimately, the logic 610 produces an 8-hot 40 bit vector 612. The vector 612 is made up of each of the one-hot 5-bit vectors 604a-604h .

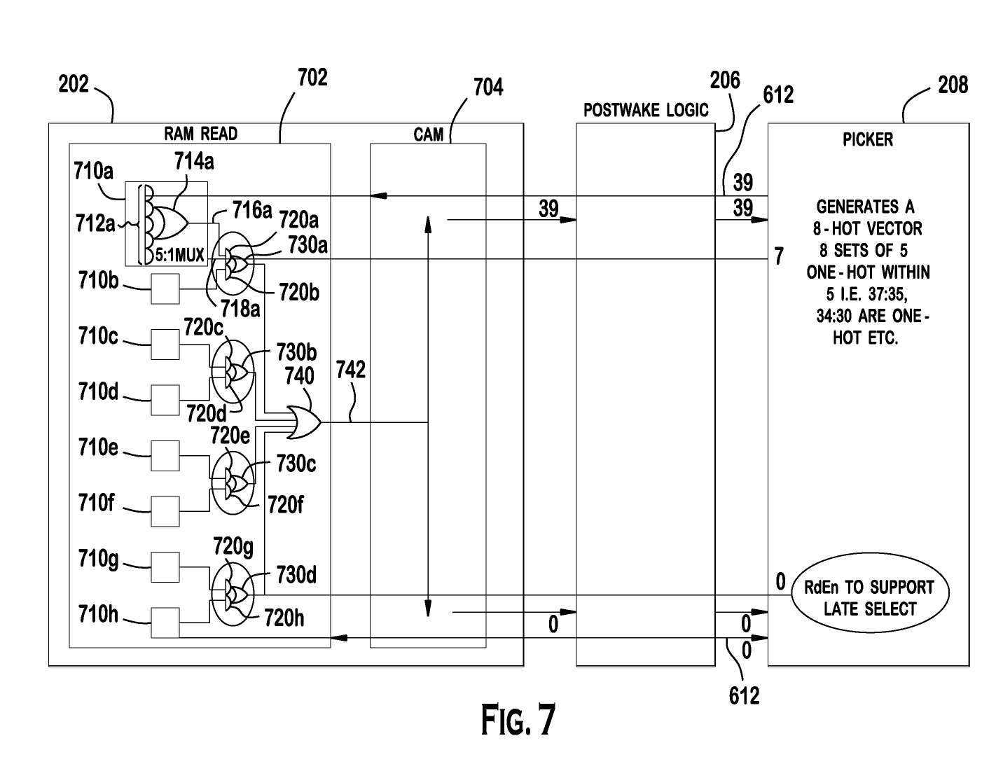

FIG. 7 is a block diagram showing the logic to identify higher priority scheduler entries, as moved into the RAM read section. FIG. 7 shows only those components necessary for understanding this portion of the description, and involves the wake array 202, the post wake logic 206, and the picker 208. The wake array 202 includes a RAM read section 702 and a CAM section 704. The input to the RAM read section 702 is the 8-hot 40-bit vector 612 from the picker 208 and is divided into eight groups of five bits each, 710a-710h.

Each group contains processing logic, including a set of five logical AND gates 712a and a logical OR gate 714a, which together function like a 5:1 multiplexer to produce a one-hot 5-bit vector 716a and a valid signal 718a. The first line in the group 710a to have a “1” value is picked from the group as the “one-hot” in the vector 716a. The valid signal 718a indicates whether the corresponding 5-bit vector 716 includes at least one “1.” If a 5-bit vector 716 has at least one instruction that is ready to be picked, then the corresponding valid signal 718 is set to “1.” If the 5-bit vector 716 does not have any ready instructions, then the corresponding valid signal 718 is set to “0.” The valid signals 718a-718h are grouped together as a read enable (RdEn) signal in the picker 208, and used to validate the RAM read out of each group 710a-710h.

The one-hot 5-bit vector 716a and the valid signal 718a are provided as inputs to a logical AND gate 720a. The AND gate 720a and a second logical AND gate 720b (associated with group 710b) are provided as inputs to a logical OR gate 730a. The logical OR gate 730a and logical OR gates 730b (associated with groups 710c and 710d), 730c (associated with groups 710e and 710f), and 730d (associated with groups 710g and 710h) are provided as inputs to logical OR gate 740. The logic combination of AND gate 720a, OR gate 730a, and OR gate 740 (the “late kill” logic) produces a tag 742 that is broadcast into the CAM section 704.

Once the valid signal 718 of one of the groups 710a-710h (taken in order from group 710a to group 710h) is a “1,” the combination of the logic gates 720, 730, and 740 kills all of the lower priority groups. For example, if group 710c is the first group with a valid signal of “1,” then groups 710a, 710b, and 710d-710h are killed by the combination of the two logical OR gates 730 and 740.

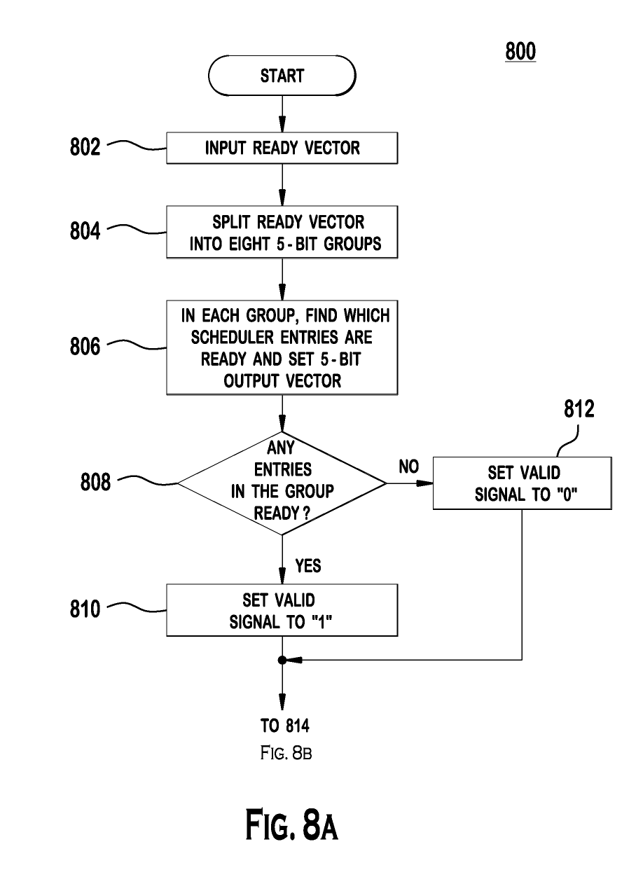

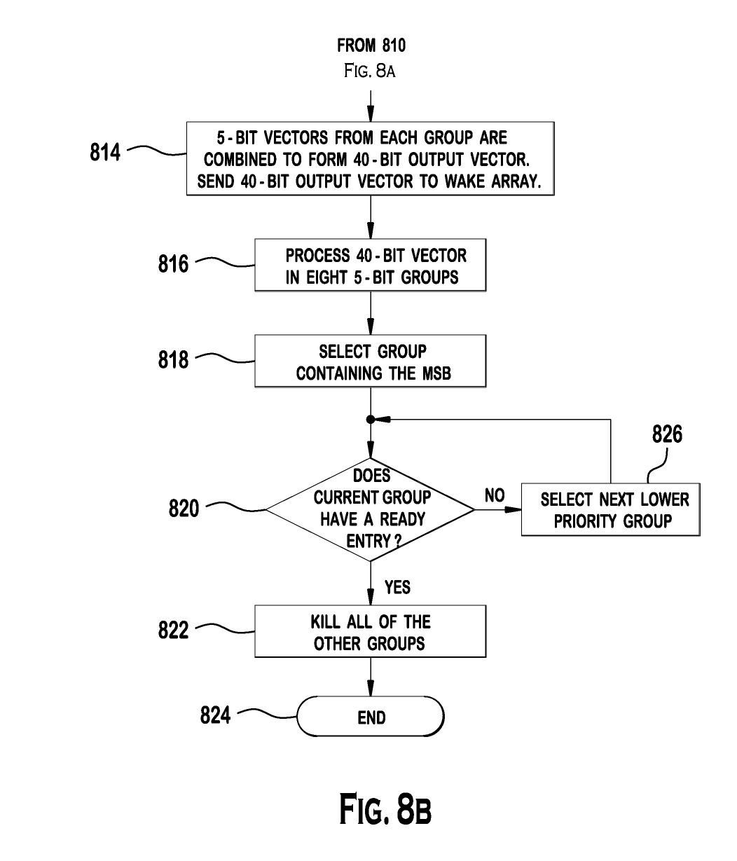

FIGS. 8A and 8B are a flowchart of a method 800 for selecting a highest priority scheduler entry. The ready vector is supplied as an input (step 802) and is split into eight 5-bit groups (step 804). In each group, logic determines which scheduler entries are ready and sets a 5-bit output vector (step 806). A determination is made whether any entries in the group are ready (step 808). If at least one entry in the group is ready, then a valid signal for the group is set to “1” (step 810). If no entries in the group are ready, then the valid signal is set to “0” (step 812). Steps 808-812 are repeated for each group.

After the valid signal is generated, for each group, the 5-bit vectors are combined to form a 40-bit output vector. The 40-bit output vector is sent to the wake array (step 814). The wake array processes the 40-bit vector in eight 5-bit groups (step 816). The group including the most significant bit of the vector is selected (step 818). A determination is made whether the selected group has a ready entry, based on the valid signal (step 820). If the current group has a ready entry, all of the other groups are killed (step 822) and the method terminates (step 824). If the current group does not have a ready entry (step 820), then the next lower priority group is selected (step 826) and the method continues by evaluating the next group (step 820).

In the event that there are no ready entries, then nothing will be selected or issued from the scheduler.

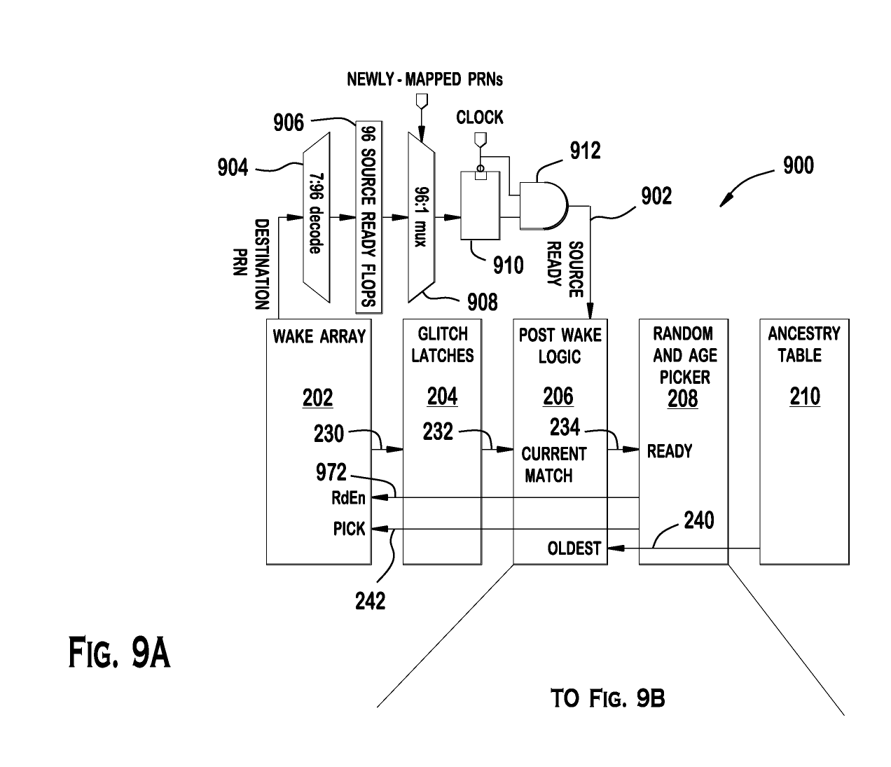

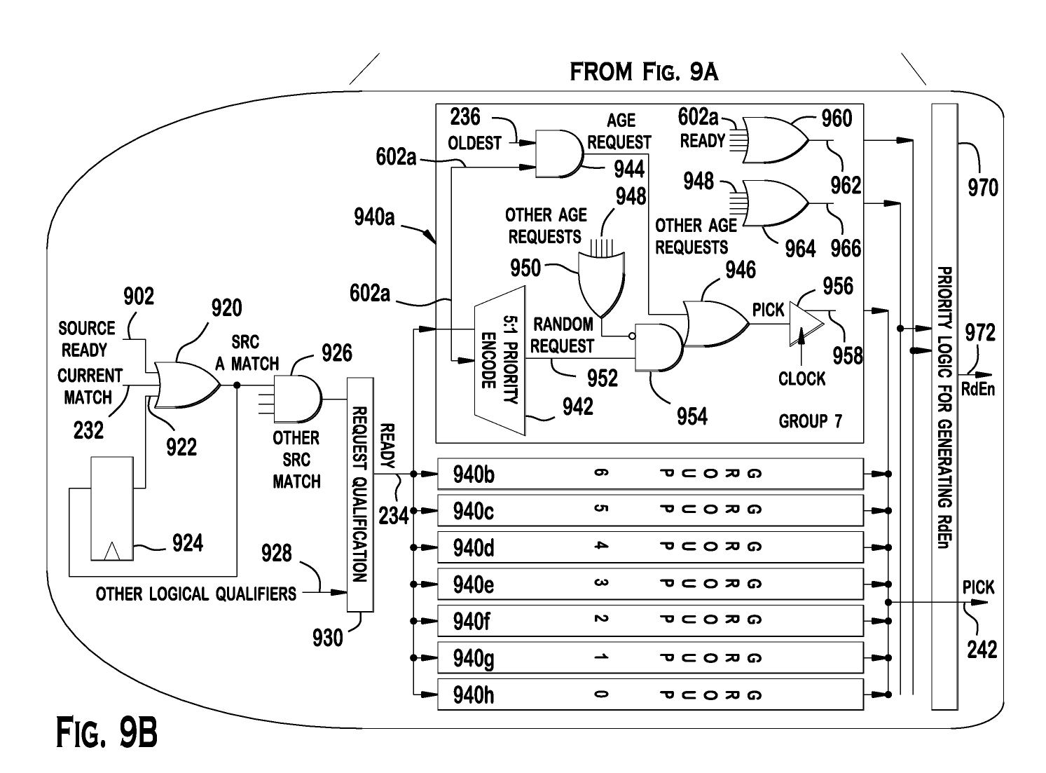

FIG. 9 is a block diagram showing source ready circuitry and logic 900 to identify higher priority scheduler entries. Elements shown in FIG. 9 that have previously been described have retained their original reference numbers.

Similar to the source ready circuitry 500, the source ready circuitry and logic 900 is used to detect the readiness of newly arrived sources of new instructions that have been dispatched to the scheduler 130. As described above, a newly mapped destination PRN is compared to all source PRNs, i.e., four sources for each entry in the scheduler 130. The wake array logic circuit 202 identifies a match between any of the source PRNs and the destination PRN and drives the current match input 232. The source ready output 902 and current match input 232 are used by the post wake logic circuit 206 to drive the ready line 234.

A newly woken up destination PRN from the wake array logic circuit 202 is sent to the source ready circuitry and logic 900 and is decoded via a 7:96 decoder 904 coupled to 96 source ready flip flops 906. It should be understood that seven bits may be decoded into 128 valid addresses; however, in this particular example, only 96 PRNs are used. The source ready flip flops 906 keep track of all sources inside the scheduler that are ready. The output of the source ready flip flops 906 is fed into a 96:1 multiplexer 908 which drives a flip flop 910. The source ready output 902 is gated via an AND gate 912.

FIG. 9 also includes a block diagram of circuitry contained in the post wake logic circuit 206 and the picker 208. The source ready signal 902 and the current match signal 232 are input to an OR gate 920 along with a gating signal 922 via a flip flop 924. The output of the OR gate 920 drives an AND gate 926. Other logical qualifiers 928 (e.g., other sources) are then combined and the ready output 234 is generated via block 930. It should be understood that the circuitry discussed above is replicated for multiple sources and for multiple scheduler entries.

The ready output 234 (40 lines) is divided into eight 5-bit groups, 602a-602h as described above in connection with FIGS. 6 and 7. Each 5-bit group is separately processed by logic blocks 940a-940h. In one embodiment, the groups 602a-602h are arranged from the most significant bit (bit position 39) to the least significant bit (bit position 0) of the original ready output 234. In an alternate embodiment, this arrangement may be reversed, but the logic blocks 940a-940h will still operate in the same manner.

The 5-bit group 602a is provided to a 40:1 priority encoder 942 and an AND gate 944. The group 602a is checked to determine if the associated scheduler entry is the oldest via the AND gate 944. If the entry is the oldest, then the entry is picked via an OR gate 946. Otherwise, the entry is picked based on all of the other age requests 948 via an OR gate 950 and a random request 952 from the priority encoder 942 by an AND gate 954. A driver 956 drives a pick signal 958 for the group 602a from the output of the OR gate 946.

The pick signal 958 for the group 602a is output from the logic block 940a. The pick signals 958 from each group 602a-602h are processed by logic (not shown) to determine which pick signal 958 has the highest priority. The highest priority pick signal 958 is output as the pick signal 242. The logic used to determine the highest priority pick signal 958 may be, for example, the logic described above in connection with FIG. 6 or 7.

The group 602a is provided to OR gate 960 to generate a valid signal 962 that indicates whether the group 602a includes at least one “1.” Similarly, the other age requests 948 are provided to OR gate 964 to generate a valid signal 966 that indicates whether there is a valid pick in the group 602a. The valid signals 962 and 966 are processed by priority logic 970 to generate a read enable signal 972 (described above in connection with FIG. 7).

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for picking an instruction for execution by a processor, comprising:
providing a multiple-entry vector, each entry in the vector including an indication of whether a corresponding instruction is ready to be picked;
partitioning the vector into equal-sized groups of one or more entries; and
evaluating each group in the vector, starting with a highest priority group, the evaluating including logically canceling all other groups in the vector when a group is determined to include an indication that an instruction is ready to be picked, whereby the vector only includes a positive indication for the one instruction that is ready to be picked.

2. The method according to claim 1, wherein:
the vector is a 40-bit vector; and
each group is 5 bits.

3. The method according to claim 1, wherein the highest priority group is any one of: the group including the most significant bit of the vector or the group including the least significant bit of the vector.

4. The method according to claim 1, wherein the evaluating further includes evaluating all of the groups in order, from highest priority to lowest priority, until a group is determined to include an indication that an instruction is ready to be picked.

5. The method according to claim 1, wherein the evaluating further includes:
receiving a signal indicating an oldest entry in the vector; and
logically canceling all other entries in the vector if the oldest entry is ready to be picked.

6. The method according to claim 1, further comprising:
setting a valid signal for each group if the group includes an indication that an instruction in the group is ready to be picked.

7. The method according to claim 6, wherein the evaluating includes using the valid signal to determine whether a group includes an instruction that is ready to be picked.

8. The method according to claim 1, wherein the method is performed by a picker device in a scheduler in the processor.

9. The method according to claim 1, wherein:
the providing is performed by a picker device in a scheduler in the processor; and
the partitioning and the evaluating are performed by a wake array device in the scheduler.

10. The method according to claim 1, further comprising:
picking the instruction indicated by the evaluated vector.

11. A scheduler in a processor for picking an instruction for execution by the processor, the scheduler comprising:
a picker, configured to provide a multiple-entry vector, each entry in the vector including an indication of whether a corresponding instruction is ready to be picked;
a wake array, configured to:
partition the vector into equal-sized groups of one or more entries; and
evaluate each group in the vector, starting with a highest priority group, wherein the evaluating includes logically canceling all other groups in the vector when a group is determined to include an indication that an instruction is ready to be picked, whereby the vector only includes a positive indication for the one instruction that is ready to be picked.

12. The scheduler according to claim 11, wherein:
the vector is a 40-bit vector; and
each group is 5 bits.

13. The scheduler according to claim 11, wherein the highest priority group is any one of: the group including the most significant bit of the vector or the group including the least significant bit of the vector.

14. The scheduler according to claim 11, wherein the wake array is further configured to evaluate all of the groups in order, from highest priority to lowest priority, until a group is determined to include an indication that an instruction is ready to be picked.

15. The scheduler according to claim 11, further comprising:
an ancestry table configured to produce a signal indicating an oldest entry in the vector,
wherein the wake array is further configured to logically cancel all other entries in the vector if the oldest entry is ready to be picked.

16. The scheduler according to claim 11, wherein the wake array is further configured to:
set a valid signal for each group if the group includes an indication that an instruction in the group is ready to be picked; and
use the valid signal to determine whether a group includes an instruction that is ready to be picked.

17. The scheduler according to claim 11, wherein the scheduler is configured to pick the instruction indicated by the evaluated vector.

18. A computer-readable storage medium storing a set of instructions for execution by one or more processors to facilitate manufacture of a scheduler, the scheduler comprising:
a picker, configured to provide a multiple-entry vector, each entry in the vector including an indication of whether a corresponding instruction is ready to be picked;
a wake array, configured to:
partition the vector into equal-sized groups of one or more entries; and
evaluate each group in the vector, starting with a highest priority group, wherein the evaluating includes logically canceling all other groups in the vector when a group is determined to include an indication that an instruction is ready to be picked, whereby the vector only includes a positive indication for the one instruction that is ready to be picked.

19. The computer-readable storage medium of claim 18, wherein the instructions are hardware description language (HDL) instructions used for the manufacture of a device.

20. The computer-readable storage medium of claim 18, wherein the scheduler is configured to pick the instruction indicated by the evaluated vector.
